(19) United States
(12) Patent Application Publication
(10) Pub. No.: US 2016/0090777 A1
(43) Pub. Date: Mar. 31, 2016

(54) ROLLER DOOR

(71) Applicant: ASSA ABLOY ENTRANCE SYSTEMS AB, Landskroma (SE)

(72) Inventors: Mark James Brunton, Auckland (NZ); Jordan Joseph Williams, Te Kauwhata (NZ)

(21) Appl. No.: 14/890,765

(22) PCT Filed: May 29, 2014
(86) PCT No.: PCT/NZ2014/000097

§ 371 Date: Nov. 12, 2015

(30) Foreign Application Priority Data
May 29, 2013 (NZ) 611212

(51) Int. Cl. E06B 9/11; E06B 3/38; E06B 3/48; E06B 9/58; E06B 9/62

(52) U.S. Cl. CPC E06B 9/11; E06B 9/58; E06B 9/62; E06B 9/582; E06B 3/48; E06B 3/38; E06B 2009/17069

(57) ABSTRACT

A roller door (11) having a door panel which includes a plurality of horizontal slats (13). The horizontal slats are made from a closed cell polyethylene foam material. The horizontal slats are held together by one or more substantially vertical and flexible elongate members (15) which are connected at an upper end to an accumulation device, for example a drum. Each horizontal slat connects with the adjacent horizontal slats with a tongue and groove joint, the joint being configured to allow a small amount of pivoting to occur at the joints so that the door panel can be rolled onto the drum. Contact between adjacent horizontal slats comprises direct contact between the foamed plastics material of each adjacent horizontal slat.

### FIELD OF THE INVENTION

This invention relates to a roller door, and in particular, but not exclusively to a rapid acting roller door for providing access to freezers and cool-stores, or to other environmentally controlled enclosures.

### BACKGROUND

There are a number of applications where rapid acting doors are required, particularly in and around cool-stores. Large volumes of goods are moved into and out of warehouses and cool-stores, often using forklifts or similar vehicles. To allow these vehicles to move freely in and out of the buildings, or between partitioned areas of a building, greater production efficiencies are achieved if the doors can open and close very rapidly.

The rapid action of the doors also minimises the time that the door is open and this in turn minimises the amount of cool air that is lost from the cool-store each time a vehicle passes in or out of the cool-store.

The doors used to provide access for forklifts need relative tall doorways to accommodate the lift section of the fork lifts. It is also advantageous if the doors do not swing toward on-coming vehicles. And for this reason roller doors are often used as they can generally be extended to accommodate the height requirements, and they do not swing toward vehicles.

In addition to the need for rapid action, there is often a need for efficient thermal insulation. For doors into and out of cool-stores the material that the doors are constructed of, should have good thermal insulation properties. The need for good thermal insulation is all the more important where the doors are very large, and have many square meters of surface area, like those used to allow access for forklifts.

Air leakage is also a potential source of heat loss, and for this reason, it is often important to reduce the air leakage through the door, when it is closed, as much as possible. Roller doors are often made of a series of linked panels, and therefore leakage paths between adjacent panels must be addressed. Leakage about the outer edges of the doors should also be controlled.

In some busy environments, it is not uncommon for doors to operate 50,000 times per year. This high usage rate, is often combined with a need for high reliability. A large factory for example cannot be expected to halt production simply because a door to a cool-store has failed. It is also advantageous if doors can act smoothly and relatively quietly, to avoid discomfort for workers in the vicinity.

The weight of the doors is also a consideration. The heavier the make up of the door, the higher the forces required to open the door quickly. The higher the overall mass of the moving parts of the door, the higher the energy requirements to accelerate the moving components each time the door is opened. The annual power consumption to repeatedly open and shut a relatively large door at speed, particularly when this occurs hundreds of times a day, can be considerable.

Inadvertent collisions between vehicles and doors sometimes occur. For this reason, it is helpful if the doors can accommodate at least minor knocks without incurring damage.

In addition, it is beneficial if the manufacturing costs of at least the major components can be minimised, and that the design allows for ease of maintenance and ease of repair to help minimise cost of ownership also.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### OBJECT

It is therefore an object of the present invention to provide a roller door which will at least go some way towards overcoming one or more of the above mentioned problems, or at least provide the public with a useful choice.

### STATEMENTS OF THE INVENTION

Accordingly, in a first aspect, the invention may broadly be said to consist in a roller door slat, wherein the slat is formed entirely from an extruded foamed plastics material, and is configured to form a pivoting joint with similarly configured roller door slats.

Preferably each roller door slat includes a tongue along one edge and a groove along an opposite edge.

In a second aspect, the invention may broadly be said to consist in a roller door having a door panel which includes a plurality of horizontal slats, the horizontal slats being held together by one or more substantially vertical and flexible elongate members which are connected at an upper end to an accumulation device, and each of the horizontal slats consists primarily of a foamed plastics material and contact between adjacent horizontal slats comprises direct contact between the foamed plastics material of each adjacent horizontal slat.

Preferably the foamed plastics material is an extruded foamed plastics material.

Preferably each horizontal slat includes a tongue along one edge and a groove along an opposite edge, and adjacent slats of the roller door are connected via a tongue and groove joint between the adjacent slats.

Preferably each horizontal slat of the door panel is connected to any adjacent horizontal slats by a rolling or pivoting joint.

Preferably the tongue and groove features of each slat are configured to accommodate the rolling or pivoting joints.

Preferably the or each rolling or pivoting joint includes a tongue and groove joint, with the groove being configured to allow the tongue to be received at a range of angles.

Preferably a radius of an apex of each tongue is smaller than a radius of a base or apex of each groove.

Preferably the or each tongue and groove joint is configured such that the tongue of one slat rolls about a line of contact between the apex of the tongue and the base or apex of the groove of an adjacent slat.

Preferably each slat to slat joint pivots generally about the centre of curvature of the radiused apexes of the respective tongues and grooves.

Preferably the foamed plastics material is a closed cell foamed plastics material.

Preferably the foamed plastics material is a polyethylene based plastics material.

Preferably at least a body section of each slat is at least fifty millimetres thick from its front face to its aft face.

Preferably the accumulation device includes a rotatable drum configured to receive the horizontal slats about its outer surface.

Preferably the or each substantially vertical and flexible elongate member is made from a webbing or strapping material.

Preferably the webbing or strapping material is a nylon based material.

Preferably the tension in the or each substantially vertical and flexible elongate member can be adjusted or set to control the amount of compressive force felt at each slat to slat joint.

Preferably the roller door includes guides at each side of the door through which the ends of each slat can slide.

Preferably the guides include seals which are configured to engage with the ends of the slats to minimise air leakage.

Preferably the door panel includes weights along its bottom edge which are configured to pull the door panel down through the guides when the door is closing.

In a third aspect, the invention may broadly be said to consist in a store room incorporating at least one roller door substantially as specified herein.

Preferably the store room is configured for operation as a cool-store.

The invention may also broadly be said to consist in the parts, elements and features referred to or indicated in the specification of the application, individually or collectively, and any or all combinations of any two or more of the parts, elements or features, and where specific integers are mentioned herein which have known equivalents, such equivalents are incorporated herein as if they were individually set forth.

### DESCRIPTION

Further aspects of the present invention will become apparent from the following description which is given by way of example only and with reference to the accompanying drawings in which:

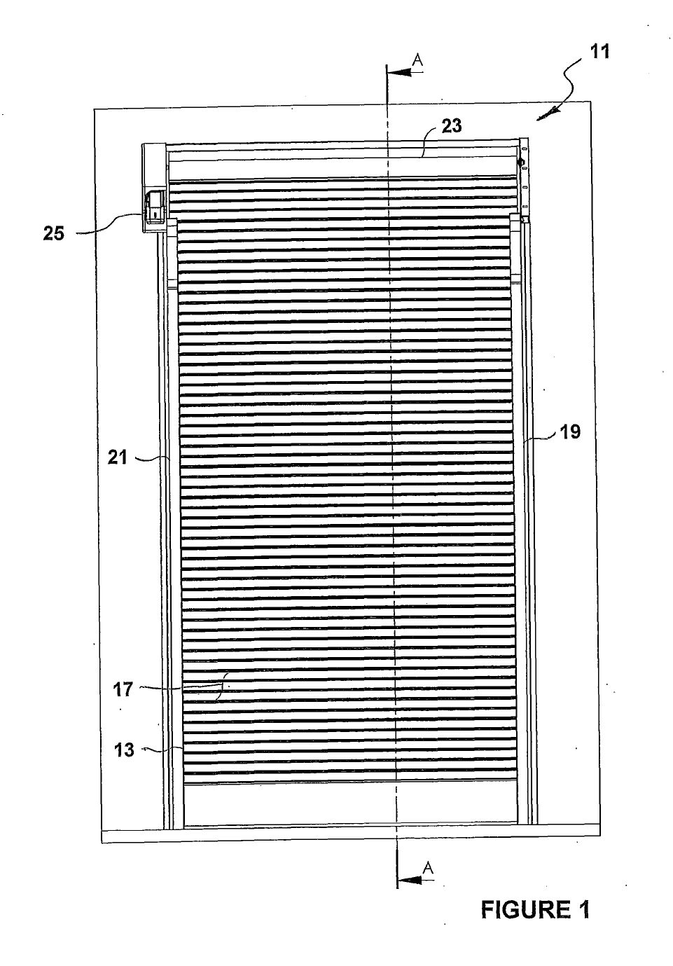

FIG. 1 is a rear elevation view of a roller door according to the present invention,

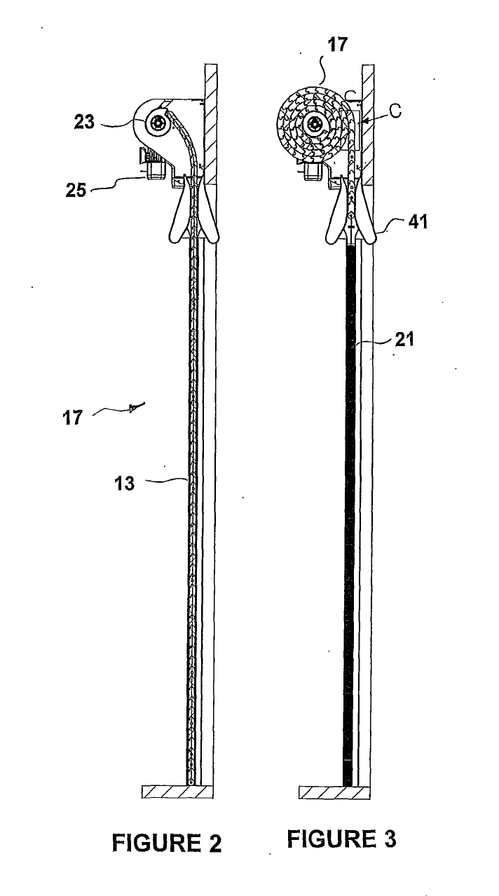

FIG. 2 is a cross sectional side elevation view A-A (as defined in FIG. 1) of the roller door shown in a closed configuration,

FIG. 3 is a side elevation view of the roller door shown in an open configuration,

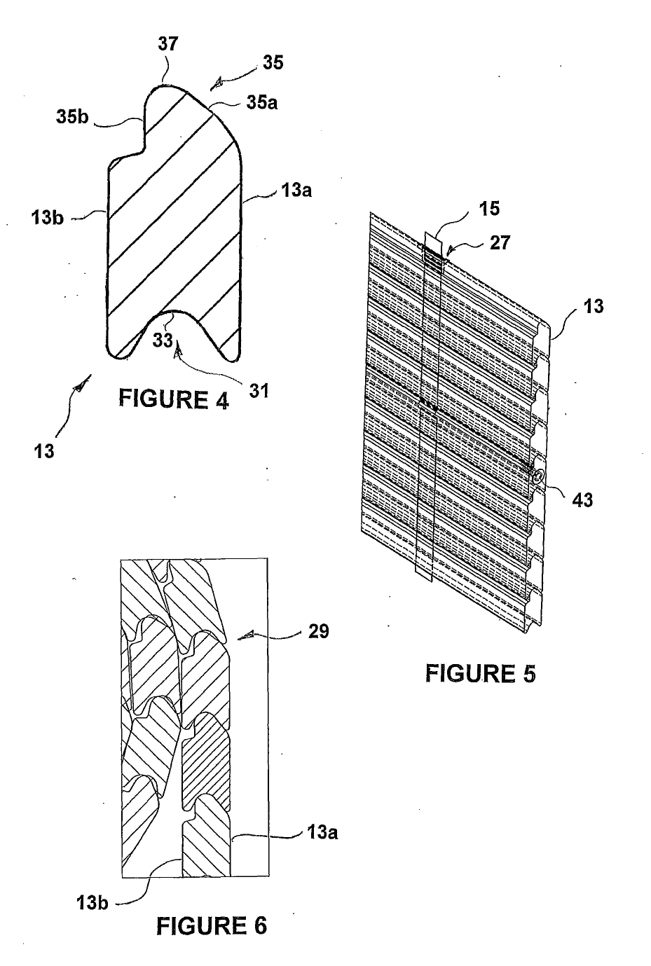

FIG. 4 is a cross sectional side elevation view of a single horizontal slat,

FIG. 5 is a perspective view of a section of the roller door showing the interconnected slats of the door, and

FIG. 6 is a partial side elevation view C (as defined in FIG. 3) showing slats transitioning from hanging vertically to becoming wrapped about a roller drum.

With reference to FIGS. 1 to 6, a roller door (11) according to the present invention will now be described. The roller door (11) has a plurality of lamellas or horizontal slats (13) which are held together by three substantially vertical and flexible elongate members or straps (15) to form the main door panel (17). The ends of the slats (13) slide within a left guide or track (19) and a right guide or track (21) at the sides of the door (11).

The straps (15) are each connected at an upper end to an accumulation device or roller drum (23). The drum (23) is turned by an electric motor (25) to open (or close) the door (11) by wrapping (or unwrapping) the main door panel (17) about the drum (23).

Each of the horizontal slats (13) is in the form of an extruded foamed plastics material. The applicants presently use an extruded closed cell foamed polyethylene material, as they find that this material works particularly well in this application.

Each horizontal slat (13) includes a tongue along one edge and a groove along an opposite edge. The slats (13) are typically eighty to one hundred and fifty millimetres wide, that is, the dimension. of each slat (13) in a vertical direction when assembled. The slats (13) are typically in the range of forty to seventy millimetres thick, ideally more than fifty millimetres thick—that is, the dimension of each slat (13) from front (13a) to back (13b). The straps (15) pass through vertical slots (27) that are formed vertically in the slats (13) at three locations along their length. The slots (27) are situated approximately centrally between the front and rear faces of the slats (13).

Adjacent slats (13) of the roller door (11) are connected via a tongue and groove joint (29) between the adjacent slats (13). As can be seen in FIG. 4, the lower edge of each slat (13) includes a groove or recess (31). The groove (31) is somewhat triangular in cross section and has a radiused base or apex (33).

The corresponding tongue (35) on each slat (13) is also somewhat triangular in cross section and includes a radiused apex (37). However, the tongue (35) includes a stepped or “cutaway” section on one side.

The tongue (35) and groove (31) features of each slat (13) are configured to accommodate rolling or pivoting joints. The rolling or pivoting joints comprise the tongue and groove joints (29) in which the tongue (35) and the groove (31) are configured to allow the tongue (35) to be received within the groove (31) at a range of angles.

The stepped or “cutaway” section of each tongue (35) faces the drum (23) when the door panel (17) wraps around the drum (23). The stepped or “cutaway” section allows the slat (13) above each slat to slat joint (29) to pivot relative to the slat (13) below each joint (29). This pivoting action at each joint (29) allows the door panel (17) to roll onto the drum (23) as shown in FIGS. 3 and 6.

The radius of the apex (37) of each tongue (35) is a little smaller than the radius of the base or apex (33) of each groove (31). Each slat to slat joint (29) pivots generally about the centre of curvature of the radiused apexes (33 and 37) of the respective tongues (35) and grooves (31). The tongue and groove joints (29) are configured such that the tongue (35) of one slat (13) rolls about the contact line between the extremity or apex (37) of the tongue (35) and the base or apex (33) of the groove (31) of the adjacent slat (13).

In this example, the opposing interior faces of the grooves (31) lie at approximately 50 degrees to each other. And the tongue (35) includes a first face (35a) which lies at about 45 degrees to the front face (13a) of the slats (13), and a second face (35b) which is substantially parallel to the front and rear faces (13a and 13b) of the slats (13). This arrangement allows each slat (13) to pivot about 25 degrees away from the line or plane of each adjacent slat (13).

The straps (15) are made from a nylon based webbing or strapping material. The straps (15) are each connected to the drum (23) at their top ends, and the straps (15) pass through the vertical slots (27) in each of the slats (13) that make up the door panel. (17). The tension in the straps (15) can be adjusted or set to control the amount of compressive force felt at each slat to slat joint (29). Since the closed cell foamed polyethylene material that the slats (13) are made of is relatively soft, it only takes a small amount of tension in the straps (15) to provide an almost air-tight joint between the slats (13) to minimise air leakage. The combination of the thermal insulating properties of the closed cell foamed polyethylene material, the thickness of the slats (13) and the air-tight joint between the slats (13), mean that the door construction is particularly useful as a door for freezer rooms and for cool-stores.

The light weight of the door panel (17) construction, which is constructed almost exclusively of foamed polyethylene, except for the straps (15) (and optionally any internal stiffeners), makes the door (11) ideal for applications requiring rapid opening and closing due to the low inertia of the door panel (17).

The drum (23) is configured to receive the slats (13) about its outer surface when the door panel (17) is lifted. The left and right guides at each side of the door secure the ends of the slats (13) when the door panel (17) is lowered. The guides include seals in the form of brush seals which engage with the relatively wide ends of the slats to further minimise air leakage.

The flexibility of the closed cell foamed polyethylene slats (13) allows the door (11) to include a “break out” feature. That is, if the door is accidentally hit by vehicle the slats of the door panel (17) can flex and the affected slats (13) can pull out of the guides (19 and 21) and swing free. Following an event of this nature, the upper guides (41) will direct the door panel (17) onto the drum (23) when the door is next raised, and subsequently the entire door panel (17) will be fed back into the guides (19 and 21) when the door panel (17) is next lowered.

The guides (19 and 21) include friction reducing liners in the form of strips of ultra high molecular weight polyethylene (UHMWPE) which help to reduce wear on the ends of the slats (13).

If it is desired to make the door panel (17) more rigid, stiffener rods (43) can be inserted through some or all of the slats (13), for example if the door (11) requires greater wind resistance. The stiffener rods can be in the form of fibreglass or carbon fibre rods or tubes for example.

The door panel (17) includes weights along its bottom edge which are configured to pull the door down panel (17) down through the guides, under the force or gravity, when the door is closing.

### VARIATIONS

To those skilled in the art to which the invention relates, many changes in construction and widely differing embodiments and applications of the invention will suggest themselves without departing from the scope of the invention as defined in the appended claims. The disclosures and the description herein are purely illustrative and are not intended to be in any sense limiting.

In the example described above, the accumulation device is in the form of a drum. In an alternative configuration, the drum could be replaced with a number of wheels about which the door panel is wound when the door is raised.

In the example described above, the slats are formed from extruded closed cell foamed polyethylene material, however it is envisaged that alternative extruded foamed plastics materials could be used.

As a variation to the use of weights to help draw the door back down when it is lowered, the door assembly (11) could include a door close assist system, for example a system of cords and pulley wheels configured to pull the door in a downward direction under the action of a drive roller(s), springs and/or bungee cords.

Trials have shown that the closed cell foamed polyethylene material used to make the slats (13) has excellent wear resistance in this application. For example, a test door has been cycled over 200,000 times and the wear in the joint between adjacent slats was not found to be excessive. Having said this, it is anticipated that lubricants, coatings, wear strips and/or a protective shell could be used or incorporated on the slats (13) to further improve wear resistance.

Similarly, sealants could be used to seal the ends of the slats where the closed cells of the foamed polyethylene material are cut when the slats (13) are cut to length, for example a polyurethane coating could be used to seal the ends.

### DEFINITIONS

Throughout this specification the word “comprise” and variations of that word, such as “comprises” and “comprising”, are not intended to exclude other additives, components, integers or steps.

### ADVANTAGES

Thus it can be seen that at least the preferred form of the invention provides a roller door which;
Is light in weight, allowing rapid opening and closing with minimal power usage,
Has good thermal insulation characteristics,
Has minimal air leakage paths,
Does not open toward on-coming vehicles,
Can be operated relatively quietly,
Includes a “break out” tolerance feature,
Is made from low cost materials and is easily repaired, and
Can tolerate minor collisions with vehicles and still operate reliably.

1. A roller door having a door panel which includes a plurality of horizontal slats, the horizontal slats being held together by one or more substantially vertical and flexible elongate members which are connected at an upper end to an accumulation device, and each of the horizontal slats consists primarily of a foamed plastics material and contact between adjacent horizontal slats comprises direct contact between the foamed plastics material of each adjacent horizontal slat.

2. A roller door as claimed in claim 1, wherein the foamed plastics material is an extruded foamed plastics material.

3. A roller door as claimed in claim 1, wherein each horizontal slat includes a tongue along one edge and a groove along an opposite edge, and adjacent slats of the roller door are connected via a tongue and groove joint between the adjacent slats.

4. A roller door as claimed in claim 1, wherein each horizontal slat of the door panel is connected to any adjacent horizontal slats by a rolling or pivoting joint.

5. A roller door as claimed in claim 3, wherein the tongue and groove features of each slat are configured to accommodate the rolling or pivoting joints.

6. A roller door as claimed in claim 5, wherein the or each rolling or pivoting joint includes a tongue and groove joint, with the groove being configured to allow the tongue to be received at a range of angles.

7. A roller door as claimed in claim 3, wherein a radius of an apex of each tongue is smaller than a radius of a base or apex of each groove.

8. A roller door as claimed in claim 7, wherein the or each tongue and groove joint is configured such that the tongue of one slat rolls about a line of contact between the apex of the tongue and the base or apex of the groove of an adjacent slat.

9. A roller door as claimed in claim 7, wherein each slat to slat joint pivots generally about the centre of curvature of the radiused apexes of the respective tongues and grooves.

10. A roller door as claimed in claim 1, wherein the foamed plastics material is a closed cell foamed plastics material.

11. A roller door as claimed in claim 1, wherein the foamed plastics material is a polyethylene based plastics material.

12. A roller door as claimed in claim 1, wherein at least a body section of each slat is at least fifty millimetres thick from its front face to its aft face.

13. A roller door as claimed in claim 1, wherein the accumulation device includes a rotatable drum configured to receive the horizontal slats about its outer surface.

14. A roller door as claimed in claim 1, wherein the or each substantially vertical and flexible elongate member is made from a webbing or strapping material.

15. A roller door as claimed in claim 1, wherein the tension in the or each substantially vertical and flexible elongate member is adjustable to allow control of the amount of compressive force felt at each slat to slat joint.

16. A roller door as claimed in claim 1, wherein the roller door includes guides at each side of the door through which the ends of each slat is able to slide.

17. A roller door as claimed in claim 16, wherein the guides include seals which are configured to engage with the ends of the slats to minimise air leakage.

18. A roller door as claimed in claim 1, wherein the door panel includes weights along its bottom edge which are configured to pull the door panel down through the guides when the door is closing.

19. A roller door slat for a roller door as claimed in claim 1, wherein the roller door slat is formed entirely from an extruded foamed plastics material.

20. A store room incorporating at least one roller door substantially as claimed in claim 1.
